(19) United States
(12) Patent Application Publication
(10) Pub. No.: US 2023/0283323 A1
(43) Pub. Date: Sep. 7, 2023

(54) BROADCAST SIGNAL TRANSMISSION METHOD FOR SIGNALING TRANSMISSION STRUCTURE BASED ON COMBINATION OF LAYERED DIVISION MULTIPLEXING AND MULTIPLE-INPUT MULTIPLE-OUTPUT, AND APPARATUS USING THE SAME

(71) Applicant: ELECTRONICS AND TELECOMMUNICATIONS RESEARCH INSTITUTE, Daejeon (KR)

(72) Inventors: Bo-Mi LIM, Daejeon (KR); Sung-Ik PARK, Daejeon (KR); Sung-Jun AHN, Daejeon (KR); Hoi-Yoon JUNG, Daejeon (KR); Hae-Chan KWON, Daejeon (KR); Nam-Ho HUR, Daejeon (KR)

(21) Appl. No.: 18/177,623

(22) Filed: Mar. 2, 2023

(30) Foreign Application Priority Data
Mar. 3, 2022 (KR) 10-2022-0027755
Mar. 2, 2023 (KR) 10-2023-0027557

(51) Int. Cl. H04B 7/0413; H04B 7/08

(52) U.S. Cl. CPC H04B 7/0413; H04B 7/0811

(57) ABSTRACT

Disclosed herein are a broadcast signal transmission method for signaling a transmission structure based on a combination of LDM technology and MIMO technology and an apparatus using the same. The broadcast signal transmission method may include generating first signaling information, indicating a transmission structure based on a combination of Multiple-Input Multiple-Output (MIMO) technology and Layered Division Multiplexing (LDM) technology, for a first subframe of a current broadcast signal frame, generating second signaling information, indicating a transmission structure based on a combination of the MIMO technology and the LDM technology, for a current subframe subsequent to the first subframe, and generating a broadcast signal using the first signaling information and the second signaling information.

### CROSS REFERENCE TO RELATED APPLICATIONS

This application claims the benefit of Korean Patent Application Nos. 10-2022-0027755, filed Mar. 3, 2022 and 10-2023-0027557, filed Mar. 2, 2023, which are hereby incorporated by reference in their entireties into this application.

### BACKGROUND OF THE INVENTION

### 1. Technical Field

The present disclosure relates generally to broadcast signal transmission/reception technology, and more particularly to broadcast signal transmission/reception technology having a transmission structure in which Layered Division Multiplexing (LDM) technology is combined with multiple-input multiple-output (MIMO) technology.

### 2. Description of the Related Art

In terrestrial broadcasting, multi-transmitting/receiving antenna technology (i.e., Multiple-Input Multiple-Output: MIMO) has been introduced to greatly improve transmission capacity compared to a Single-Input Single-Output (SISO) system without adding frequency resources. MIMO technology in which two antennas are used for each of transmission and reception has been applied to current terrestrial broadcasting including ATSC 3.0. MIMO technology may be regarded as technology in which transmitting/receiving antennas are added and spatially different transmission media are added, and in which an amount of data may be additionally delivered in proportion to the number of antennas that are added, thus improving transmission efficiency. Further, transmission quality may be improved by means of a diversity gain acquired by delivering the same data through different paths. Therefore, by utilizing the diversity gain, the transfer rate may be increased about twice that of an existing SISO system in the same bandwidth, and not only 4K Ultra-High-Definition (UHD) broadcasting service but also an 8K-UHD broadcasting service may be realized.

Furthermore, in terrestrial broadcasting, transmission (physical layer) signal multiplexing technology has been introduced to enable two or more broadcasting services to have different broadcasting service provision areas or to be received in different environments in a single broadcasting channel. The most representative multiplexing technology includes Time Division Multiplexing (TDM) and Frequency Division Multiplexing (FDM) which utilize orthogonality between transmission resources. In addition, with the development of recent signal processing technology, Layered Division Multiplexing (LDM) technology in which two or more broadcasting services can be independently provided without maintaining orthogonality between transmission resources has been introduced. Such LDM is technology which transmits two different broadcast signals while sharing the same time and frequency resources with equal or different powers, and which allows a receiver to demodulate the two broadcast signals using the fact that two broadcast signals have different reception qualities. Such LDM based on sharing of orthogonal transmission resources may have improved transmission efficiency that is a maximum of 30% higher than that of TDM and FDM.

In a current terrestrial broadcasting system, Layered Division Multiplexing (LDM) technology has been applied using only two layers. Also, of the two layers, one layer which corresponds to a signal having relatively high power or relatively robust reception performance is referred to as a “core layer: CL”, and the other layer is referred to as an “Enhanced Layer: EL”. Generally, the core layer delivers a broadcasting service for the case where a quality requirement is low and a reception environment is inferior as in the case of mobile broadcasting which is provided to smartphones or media terminals in vehicles, and the enhanced layer delivers a high-quality broadcasting service suitable for a large-scale screen such as a television (TV) in home and for a fixed reception environment.

Terrestrial broadcasting systems introduced to date supports each of MIMO technology and LDM technology, but does not support transmission technology in which the two types of technologies are combined with each other. However, recently, in order to transmit Ultra-High-Definition (UHD) media including 8K-UHD media and hyper-realistic media, introduction of MIMO technology, LDM technology, and a combination of the two technologies into a terrestrial broadcasting system is under discussion. A terrestrial broadcasting system in which MIMO technology and LDM technology are combined may be implemented as a method for maximally guaranteeing compatibility with existing transmission systems and as a transmission/reception method differentiated from the existing transmission systems. In relation to the methods, technology which is under more active discussion compared to the conversion cycle of the terrestrial broadcasting system is to maximally guarantee compatibility with existing transmission systems. However, when 8K-UHD activation is realized through active introduction or the like of MIMO technology, the corresponding technology may be taken into consideration even in the case where compatibility is not guaranteed.

### PRIOR ART DOCUMENTS

### Patent Documents

(Patent Document 1) Korean Patent No. 10-1223605, Date of Registration: Jan. 11, 2013 (Title: System and Method, Transmitter and Transmitting Method, Receiver and Receiving Method for MIMO Communication)

### SUMMARY OF THE INVENTION

Accordingly, the present disclosure has been made keeping in mind the above problems occurring in the prior art, and an object of the present disclosure is to improve the performance of a broadcasting system to which Multiple-Input Multiple-Output (MIMO) technology and Layered Division Multiplexing (LDM) technology are applied.

Another object of the present disclosure is to provide a broadcasting service to which a combination of MIMO technology and LDM technology is applied while maintaining compatibility with an existing receiver.

A further object of the present disclosure is to efficiently provide a broadcasting system by managing a transmit antenna depending on the purpose of service and to improve reception performance by controlling a receiving antenna and an operation when signaling information indicating a signal transmission structure based on a combination of MIMO technology and LDM technology is transferred.

Yet another object of the present disclosure is to allow an existing terminal to which a combination of MIMO technology and LDM technology is not applied to receive a terrestrial broadcast signal including a core layer signal and to acquire transmission information in the same manner as an existing scheme.

In accordance with an aspect of the present disclosure to accomplish the above object, there is provided a broadcast signal transmission method, including generating first signaling information, indicating a transmission structure based on a combination of Multiple-Input Multiple-Output (MIMO) technology and Layered Division Multiplexing (LDM) technology, for a first subframe of a current broadcast signal frame; generating second signaling information, indicating a transmission structure based on a combination of the MIMO technology and the LDM technology, for a current subframe subsequent to the first subframe; and generating a broadcast signal using the first signaling information and the second signaling information.

The first signaling information may be included in basic transmission information (L1-BASIC SIGNAL) of a preamble of the broadcast signal, and the second signaling information may be included in detailed transmission information (L1-DETAIL SIGNAL) of the preamble of the broadcast signal.

Each of the first signaling information and the second signaling information may indicate a transmission chain through which a combined signal of a core layer signal and an enhanced layer signal passes, and a transmit antenna to which the combined signal is transferred.

Each of the first signaling information and the second signaling information may further indicate that a combination of the MIMO technology and the LDM technology is not applied.

A first receiver that supports only the LDM technology may receive the combined signal, demodulate only the core layer signal from the combined signal, and process the enhanced layer signal as a noise signal.

A second receiver that supports both the LDM technology and the MIMO technology may receive the combined signal and individually demodulate the core layer signal and the enhanced layer signal from the combined signal.

The second receiver may acquire information about the transmission structure of the first subframe of the current broadcast signal frame through the first signaling information, and may acquire information about the transmission structure of the current subframe subsequent to the first subframe of the current broadcast signal frame through the second signaling information.

In accordance with another aspect of the present disclosure to accomplish the above object, there is provided a broadcast signal transmission method, including generating signaling information, indicating a transmission structure based on a combination of Multiple-Input Multiple-Output (MIMO) technology and Layered Division Multiplexing (LDM) technology, for a current subframe including a first subframe of a current broadcast signal frame; and generating a broadcast signal using the signaling information.

In accordance with a further aspect of the present disclosure to accomplish the above object, there is provided a broadcast signal transmission apparatus, including a first signaling information generation unit for generating first signaling information, indicating a transmission structure based on a combination of Multiple-Input Multiple-Output (MIMO) technology and Layered Division Multiplexing (LDM) technology, for a first subframe of a current broadcast signal frame; a second signaling information generation unit for generating second signaling information, indicating a transmission structure based on a combination of the MIMO technology and the LDM technology, for a current subframe subsequent to the first subframe; and a broadcast signal generation unit for generating a broadcast signal using the first signaling information and the second signaling information.

The first signaling information may be included in basic transmission information (L1-BASIC SIGNAL) of a preamble of the broadcast signal, and the second signaling information may be included in detailed transmission information (L1-DETAIL SIGNAL) of the preamble of the broadcast signal.

Each of the first signaling information and the second signaling information may indicate a transmission chain through which a combined signal of a core layer signal and an enhanced layer signal passes, and a transmit antenna to which the combined signal is transferred

Each of the first signaling information and the second signaling information may further indicate that a combination of the MIMO technology and the LDM technology is not applied.

A first receiver that supports only the LDM technology may receive the combined signal, demodulate only the core layer signal from the combined signal, and process the enhanced layer signal as a noise signal.

A second receiver that supports both the LDM technology and the MIMO technology may receive the combined signal and individually demodulate the core layer signal and the enhanced layer signal from the combined signal.

The second receiver may acquire information about the transmission structure of the first subframe of the current broadcast signal frame through the first signaling information, and may acquire information about the transmission structure of the current subframe subsequent to the first subframe of the current broadcast signal frame through the second signaling information.

In accordance with yet another aspect of the present disclosure to accomplish the above objects, there is provided a broadcasting signal transmission apparatus, including a signaling information generation unit for generating signaling information indicating a transmission structure based on a combination of Multiple-Input Multiple-Output (MIMO) technology and Layered Division Multiplexing (LDM) technology for a current subframe including a first subframe of a current broadcast signal frame; and a broadcast signal generation unit for generating a broadcast signal using the signaling information.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are diagrams illustrating an example of a system in which MIMO and LDM are combined;

FIGS. 3 and 4 are diagrams illustrating an example of a receiver for receiving a signal in which MIMO and LDM are combined;

FIGS. 5, 6, 7, and 8 are diagrams illustrating an example of a system in which MIMO and LDM are combined such that the outputs of transmit antennas can be identified;

FIG. 9 is a diagram illustrating another example of a receiver for receiving a signal in which MIMO and LDM are combined;

FIG. 10 is an operation flowchart illustrating a broadcast signal transmission method according to an embodiment of the present disclosure;

FIG. 11 is a diagram illustrating an example of a transmission signal structure of a terrestrial broadcasting system according to the present disclosure;

FIG. 12 is a diagram illustrating an example in which first signaling information is defined according to the present disclosure;

FIG. 13 is a diagram illustrating an example in which second signaling information is defined according to the present disclosure;

FIG. 14 is an operation flowchart illustrating a broadcast signal transmission method according to another embodiment of the present disclosure;

FIG. 15 is a diagram illustrating an example in which the signaling information illustrated in FIG. 14 is defined;

FIG. 16 is a block diagram illustrating a broadcast signal transmission apparatus according to an embodiment of the present disclosure;

FIG. 17 is a block diagram illustrating a broadcast signal transmission apparatus according to another embodiment of the present disclosure; and

FIG. 18 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof

Hereinafter, preferred embodiments of the present disclosure will be described in detail with reference to the attached drawings.

A terrestrial broadcasting system based on ATSC 3.0 standards includes a multi-transmitting/receiving antenna technology (Multiple-Input Multiple-Output: MIMO) and Layered Division Multiplexing (LDM) technology. Also, although not included in the current terrestrial broadcasting system, transmission efficiency may be improved when the two types of technology are combined. A scheme for combining two types of technologies in consideration of compatibility with an existing receiver corresponds to a form in which a core layer signal is transmitted in the same manner as an existing method, but MIMO technology is applied only to an enhanced layer signal.

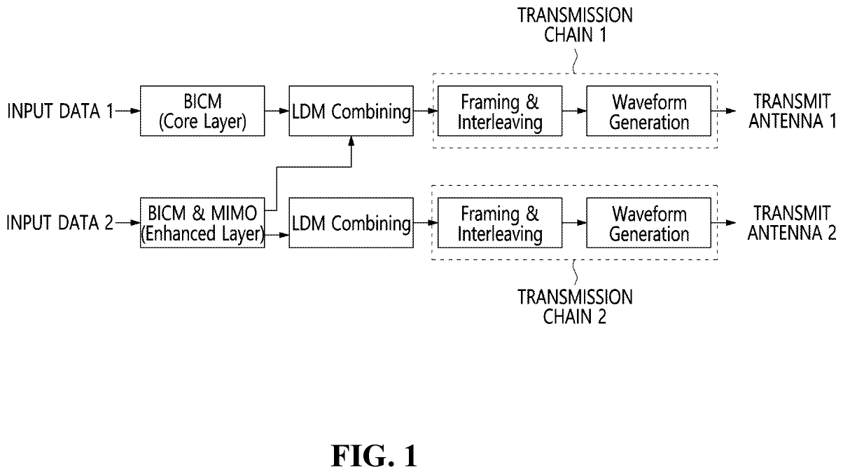

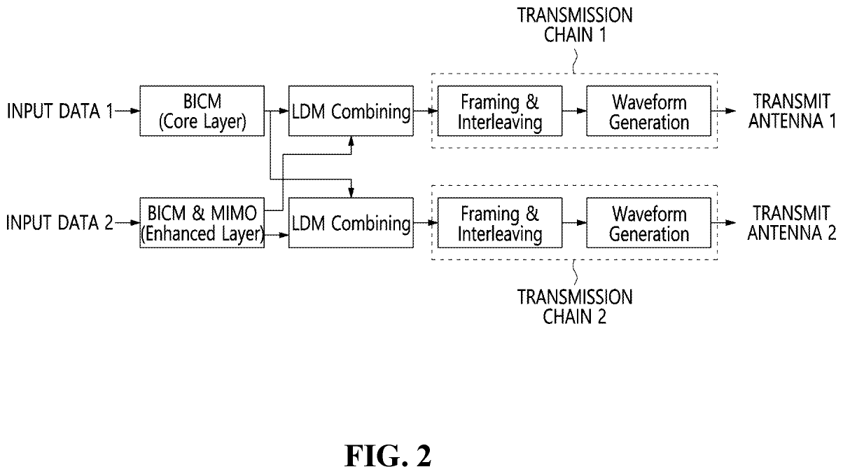

In this case, a combination of MIMO technology and LDM technology may be delivered in various structures in consideration of compatibility with an existing receiver, the purpose and form of service desired to be provided by a broadcasting company, a reception environment such as a mobile environment or a fixed environment, etc., and FIGS. 1 and 2, which will be described below, correspond to embodiments thereof

FIGS. 1 and 2 are diagrams illustrating an example of a system in which MIMO and LDM are combined.

First, FIG. 1 illustrates a terrestrial broadcasting system in which MIMO technology and Layered Division Multiplexing (LDM) technology are combined, wherein input data 1 transferred through a core layer is delivered only through transmit antenna 1. Further, MIMO technology is applied to input data 2 transferred through an enhanced layer, and thus input data 2 is divided into two different streams. Here, one stream is combined with the core layer, and LDM technology is applied to a combined stream. The other stream is configured to fit only the power ratio thereof to an enhanced layer combined with the core layer, without being combined with the core layer, and LDM technology is applied to the other stream. Furthermore, respective signals may go through transmission chains thereof, each including a framing and interleaving module and a waveform generation module, and may then be transferred to transmit antenna 1 and transmit antenna 2, respectively.

Furthermore, FIG. 2 illustrates a terrestrial broadcasting system in which MIMO technology is combined with LDM technology, and shows an example of a combination form different from that of FIG. 1. Compared to the embodiment of FIG. 1, input data 1 transferred through a core layer in FIG. 2 may be delivered through both transmit antenna 1 and transmit antenna 2. Here, in the same manner as the embodiment of FIG. 1, MIMO technology is applied only to an enhanced layer which transfers input data 2. However, in FIG. 2, input data 2 may be divided into two streams through MIMO technology, and the two streams may be individually combined with the same core layer, and may be delivered through transmit antenna 1 and transmit antenna 2, respectively.

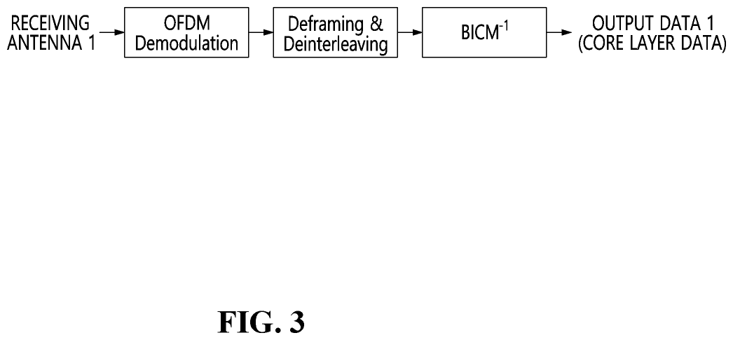

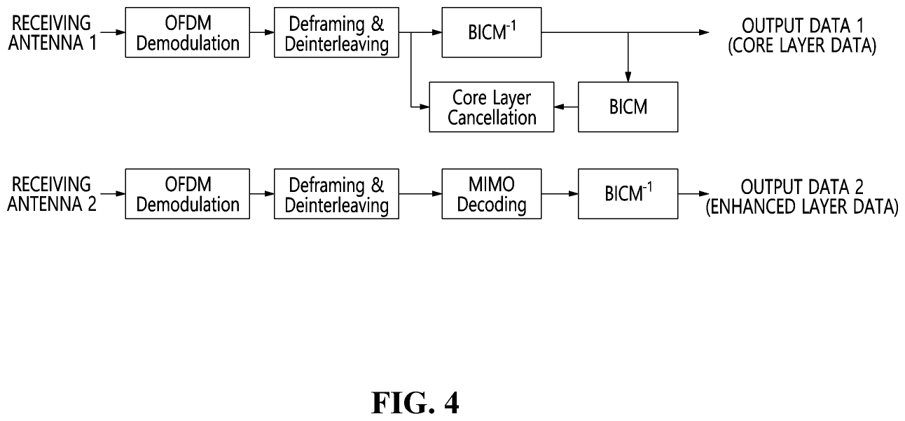

FIGS. 3 and 4 are diagrams illustrating an example of a receiver for receiving a signal in which MIMO and LDM are combined.

First, the receiver illustrated in FIG. 3 may be implemented using only one receiving antenna, and may receive a broadcast signal delivered through a core layer. That is, an existing receiver which does not support MIMO technology or a combination of MIMO technology and LDM technology may estimate only a channel environment between transmit antenna 1 described in FIG. 1 or 2 and a receiving antenna.

Also, the receiver illustrated in FIG. 4 may include two receiving antennas, may receive multiple antenna signals transferred from transmit antenna 1 and transmit antenna 2 described in FIG. 1 or 2, and may estimate all channel environments between respective transmitting/receiving antennas.

For example, the receiver illustrated in FIG. 4 may demodulate core layer data from a signal received through receiving antenna 1. Also, after a core layer signal is removed from the signal received through receiving antenna 1, enhanced layer data may be demodulated by applying MIMO technology to enhanced layer signals received through two receiving antennas.

As described above, when MIMO technology is applied only to the enhanced layer, signals corresponding to an existing terrestrial broadcasting service may be provided only through the core layer. In this case, the existing receiver conforming to the structure according to the embodiment of FIG. 3 may regard an enhanced layer signal as noise, and may receive the terrestrial broadcasting service delivered through the core layer. Further, the receiver conforming to the structure according to the embodiment of FIG. 4 may demodulate data transferred to the enhanced layer through signaling indicating whether sub-element technologies are applied to a physical layer pipe (PLP) corresponding to the enhanced layer. For example, sub-element technologies of MIMO technology may include technologies such as stream combining, IQ polarization interleaving, and phase hopping.

In the case where the broadcasting system supports both the embodiments of FIGS. 1 and 2, the receiver needs to distinguish the transmission structures according to the embodiments of FIGS. 1 and 2 from each other. However, the receiver cannot infer each transmission structure using only conventionally proposed signaling.

Therefore, there is required a new method capable of transmitting/receiving a signal in which MIMO technology is combined with LDM technology by distinguishing different transmission structures from each other while solving the problem of compatibility with the existing receiver. Furthermore, in addition to the embodiments illustrated in FIGS. 1 and 2, the receiver needs to also identify a transmission structure having antenna polarization characteristics, different from those of existing in-home fixed broadcasting, as in the case of a mobile broadcasting service for vehicles.

The outputs of two transmit antennas described in FIGS. 1 and 2 may be different signals to which different pilots are applied, and may be signals generated through different transmission chains. Furthermore, MIMO technology provided by terrestrial broadcasting companies generally utilizes two orthogonal antennas such as a vertical antenna and a horizontal antenna. Therefore, the receiver needs to distinguish signals transferred through respective transmit antennas from each other and to identify and receive an orthogonal dual-polarized antenna signal or a single-antenna signal by establishing a criterion having priority.

In addition, in the case where the purpose of service desired to be provided by a broadcasting company is to provide entertainment service to a vehicle and a mobile reception environment is taken into consideration and the case where the purpose of service is to provide high-quality content to in-home devices and a fixed reception environment is taken into consideration, propagation characteristics and reception performance may appear differently depending on a broadcast signal transmission method to which MIMO technology and LDM technology are applied and a scheme for applying transmitting/receiving antennas. When this difference is utilized, the broadcasting company may configure a more profitable broadcasting environment in conformity with the purpose of service.

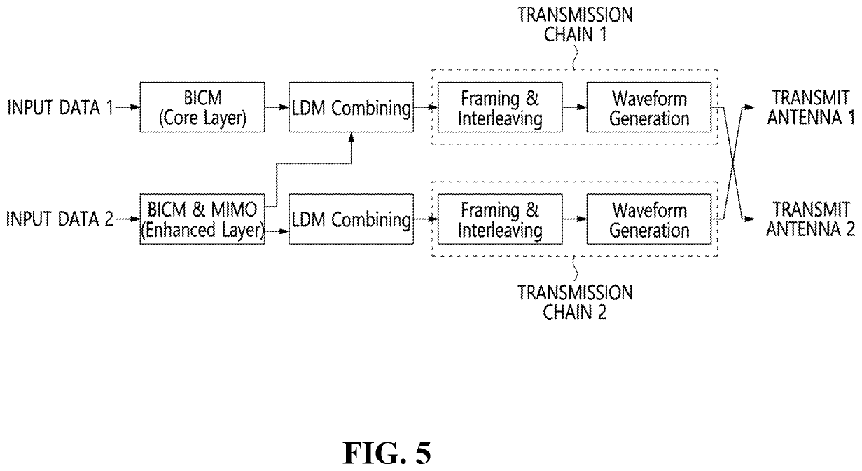

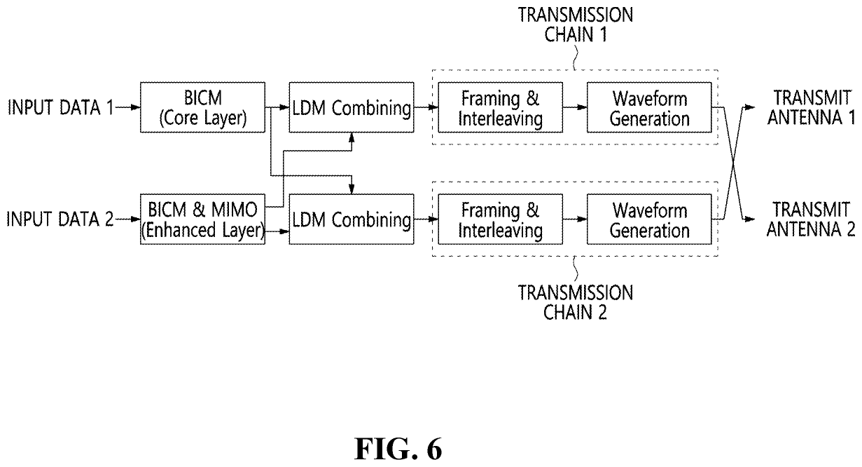

Therefore, in the case where the output of transmit antenna 1 and the output of transmit antenna 2 need to be distinguished and separately received depending on orthogonal transmit antenna characteristics, broadcasting based on a combination of MIMO technology and LDM technology needs to be provided through the transmission structure shown in the embodiments of FIGS. 5 and 6, as well as that in the embodiment of FIG. 1 or 2. In this case, transmission methods including channel encoding and modulation on input data, MIMO signal processing, layered division multiplexing (LDM) signal processing, and transmission chains may remain the same as the embodiments of FIGS. 1 and 2.

Here, in the transmission structures of FIGS. 1 and 2 and FIGS. 5 and 6, changes in the outputs of transmit antennas may be performed to change connections thereof in a manual manner by the corresponding broadcasting company, or in an automatic manner on a broadcast transmission system.

When the connections are changed in a manual manner, broadcast signals may be transmitted by switching only final antenna connections with each other without modifying transmission chains which generate broadcast signals.

Alternatively, when the connections are automatically changed on the broadcast transmission system, a transmission chain connected to transmit antenna 1 and a transmission chain connected to transmit antenna 2 may be operated contrary to each other between FIGS. 1 and 5 and between 2 and 6. That is, transmission chain 1 illustrated in FIG. 5 may be operated in the same manner as transmission chain 2 illustrated in FIG. 1, and the output thereof may be transferred to transmit antenna 1, and thus broadcast signals may be transmitted in the same manner as an antenna switch method.

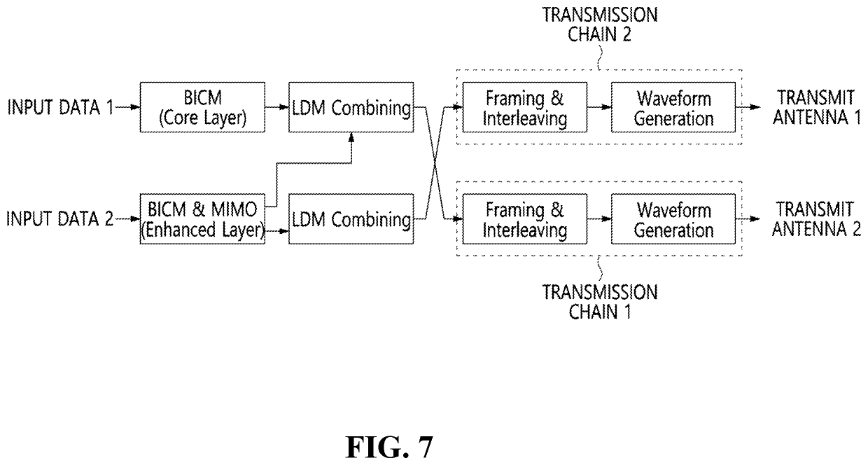

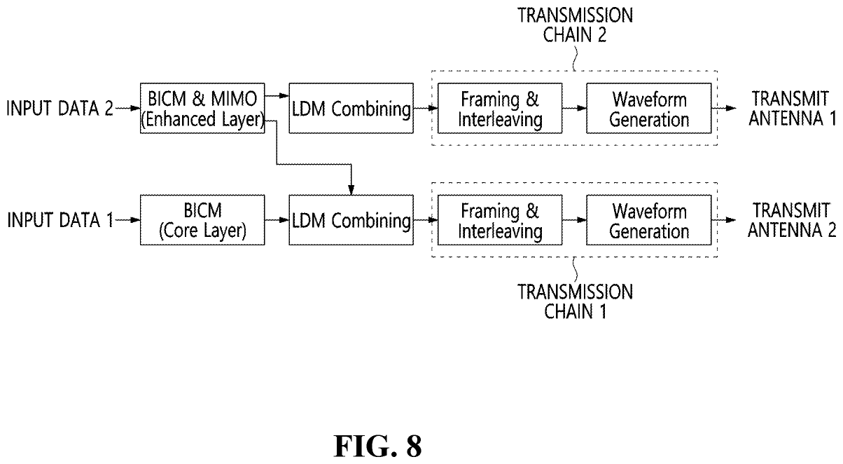

When the operations of transmission chain 1 shown in FIG. 5 and transmission chain 2 are switched with each other, the system may be operated in a structure according to an embodiment illustrated in FIG. 7. That is, one stream of the enhanced layer to which MIMO technology is applied is combined with the stream of the core layer, and thereafter a combined stream needs to be transferred to transmission chain 1 and to be output through transmit antenna 2. The other stream of the enhanced layer needs to be transferred to transmission chain 2 and to be output through transmit antenna 1. Consequently, it may be considered that the changed structure is identical to a transmission structure according to an embodiment shown in FIG. 8.

Therefore, a scheme in which the transmission structure in the embodiment illustrated in FIG. 2 is changed to the transmission structure illustrated in FIG. 6 may be processed in the same manner as in the above description. Further, although not illustrated in the drawings, as in the case where the structure illustrated in FIG. 1 is expanded in the structure of FIG. 7 or 8, the structure illustrated in FIG. 2 may also be expanded in a form in which the operations of transmission chain 1 and transmission chain 2 are changed with each other.

A receiver that supports the reception of a combined signal in FIGS. 1 and 2 and FIGS. 5 and 6 needs to distinguish signals transferred through transmit antenna 1 and transmit antenna 2 from each other, and to operate receiving antenna 1 and receiving antenna 2 in accordance with the distinguished signals.

Here, the connection of the receiving antennas may also be manually selected and performed by a user, or may be automatically selected and performed by the receiver, and thus reception signals may be processed.

When only antenna switching is made between the receiver and the receiving antennas, the receiver may receive signals without requiring a change in the detailed configuration thereof. However, when antenna switching is not made between the receiver and receiving antennas, detailed reception functions and operational configurations corresponding to respective receiving antennas may be implemented contrary to each other depending on a change from the scheme of FIG. 1 to the scheme of FIG. 5, a change from the scheme of FIG. 2 to the scheme of FIG. 6, and changes to schemes reverse thereto.

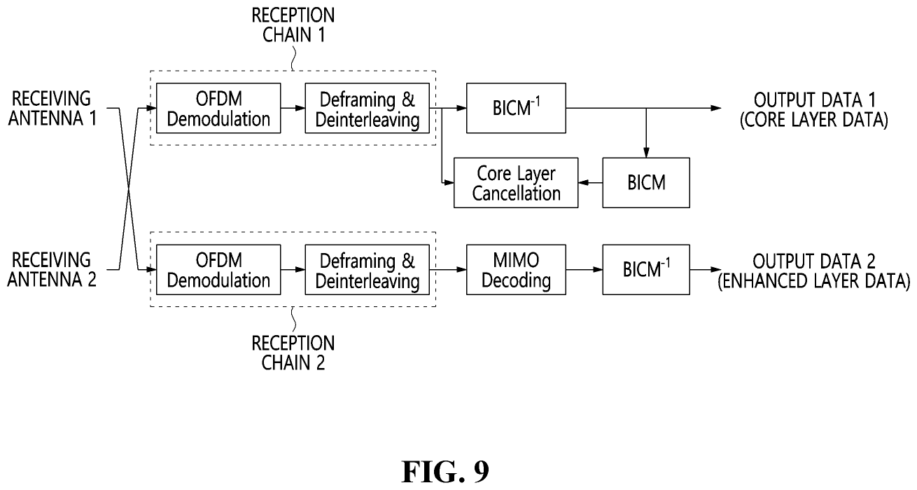

For example, in the case of signals to be transmitted in the state in which a transmission configuration is changed from the scheme of FIG. 1 to that of FIG. 5, the signals need to be processed by changing the configuration of the receiver from the scheme of FIG. 4 to that of FIG. 9.

That is, in the case of signals to be transmitted in the state in which a transmission configuration is changed from the scheme of FIG. 1 to that of FIG. 5, a pilot pattern transferred to transmit antenna 1 and a pilot pattern transferred to transmit antenna 2 are reversed to each other. Therefore, a signal transferred through transmit antenna 1 in the transmission structure of FIG. 5 is received through receiving antenna 1 of FIG. 9, and a signal transferred through transmit antenna 2 in the transmission structure of FIG. 5 is received through receiving antenna 2 of FIG. 9, thus deriving optimal reception performance. Here, the signal received through receiving antenna 1 may be demodulated through reception chain 2, and the signal received through receiving antenna 2 may be demodulated through reception chain 1.

Here, the receiver of FIG. 3 provided with only one receiving antenna may receive signals both from transmit antenna 1 and from transmit antenna 2 even though the receiver has only receiving antenna 1. That is, the existing receiver may process signals according to the embodiments of FIGS. 5 and 6, as in the case of the embodiments of FIGS. 1 and 2.

However, in the case of the receiver illustrated in FIGS. 4 and 9, better reception quality may be maintained only when the characteristics of transmit antenna 1 and receiving antenna 1 and the characteristics of transmit antenna 2 and receiving antenna 2 are similar to each other. Consequently, the receiver needs to be able to determine the type of the transmission structure of the transmitter, and transmission signaling information including the transmission structure type needs to be delivered to the receiver.

Here, the existing receiver having the same structure as the receiver of FIG. 3 may be incapable of receiving signals due to signaling of the transmission structure to be newly added. Therefore, there is a need to design transmission signaling related to the transmission structure so that a receiver to which a combination of MIMO and LDM is applied is normally operated while the existing receiver receives a core layer signal.

Hereinafter, in order to solve the above problems, broadcast signal transmission technology for signaling a transmission structure based on a combination of LDM technology and MIMO technology will be described.

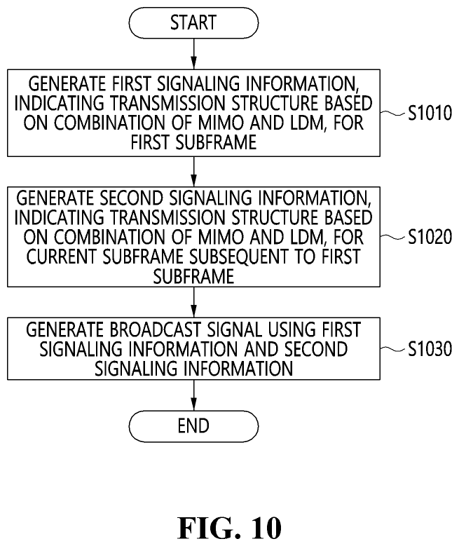

FIG. 10 is an operation flowchart illustrating a broadcast signal transmission method according to an embodiment of the present disclosure.

Referring to FIG. 10, the broadcast signal transmission method according to the embodiment of the present disclosure generates first signaling information, indicating a transmission structure based on a combination of Multiple-Input Multiple-Output (MIMO) technology and Layered Division Multiplexing (LDM) technology, for a first subframe of a current broadcast signal frame at step S1010.

Further, the broadcast signal transmission method according to the embodiment of the present disclosure generates second signaling information, indicating a transmission structure based on a combination of MIMO technology and LDM technology, for a current subframe subsequent to the first subframe of the current broadcast signal frame at step S1020.

Here, the first signaling information may be included in basic transmission information L1-BASIC SIGNAL of the preamble of a broadcast signal, and the second signaling information may be included in detailed transmission information L1-DETAIL SIGNAL of the preamble of the broadcast signal.

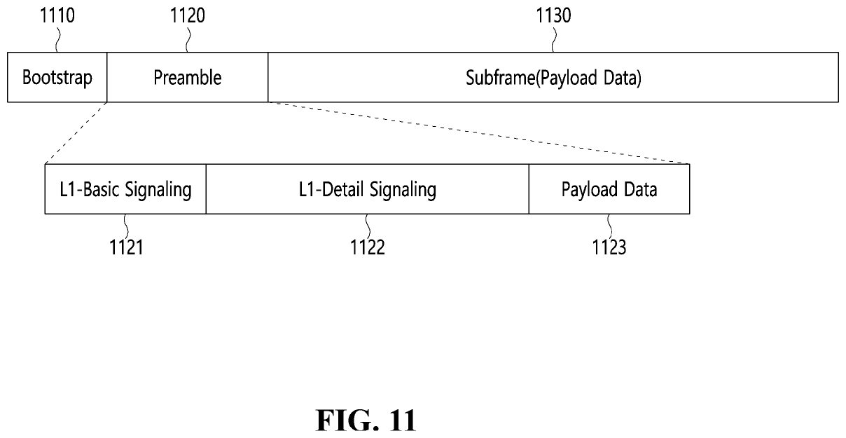

For example, FIG. 11 is a diagram illustrating an example of the transmission signal structure of a terrestrial broadcasting system, and shows that the transmission signal of the terrestrial broadcasting system is configured such that a receiver acquires transmission information by stages through a hierarchical structure.

For example, the transmitting end of the terrestrial broadcasting system may transfer a minimum amount of transmission information required for demodulating a current preamble 1120 through a bootstrap 1110, and may transfer current channel information and transmission information L1-Signaling of a subframe 1130, in which actual payload data is delivered, through the preamble 1120. The transmission information may be configured to be subdivided into fields of basic transmission information 1121 and detailed transmission information 1122. The basic transmission information 1121 may include information for identifying the entire transmission structure of the first subframe.

Here, individual subframes may be combined to have different signal qualities by multiplexing multiple Physical Layer Pipes (PLPs), each of which is a payload data group having the same signal quality. Therefore, information about the entire transmission structure of each subframe appearing subsequent to the first subframe of the current broadcast signal frame and a transmission method applied to the physical layer pipes of all subframes including the first subframe of the current broadcast signal frame may be transferred through the detailed transmission information 1122.

Here, because the combination of MIMO technology and LDM technology may be applied to each subframe, signaling information may be configured on a subframe basis.

Here, each of the first signaling information and the second signaling information may indicate a transmission chain through which a combined signal of a core layer signal and an enhanced layer signal passes, and a transmit antenna to which the combined signal is transferred.

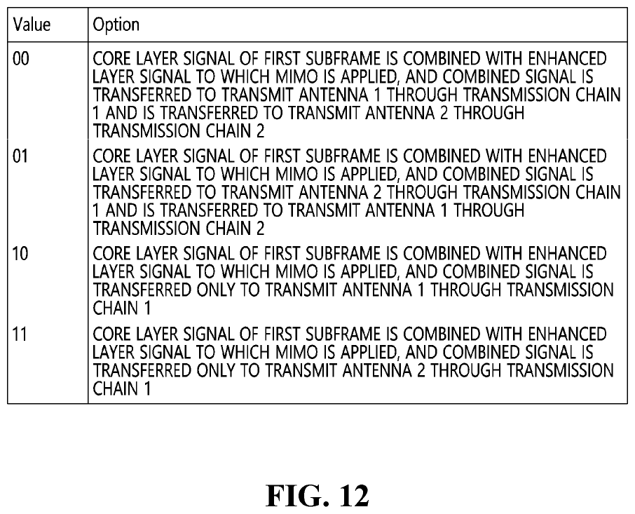

For example, FIG. 12 defines L1B_first_sub_lyrd_cl_pol, which is an example of the first signaling information about a transmission structure indicating how MIMO technology and LDM technology are combined with the first subframe.

Referring to FIG. 12, for the first subframe, when a core layer signal and an enhanced layer signal are combined with each other and a combined signal is transferred both through transmit antenna 1 and through transmit antenna 2, as in the case of the embodiment of FIG. 2, the first signaling information may be transferred as a value of ‘00’. Alternatively, as in the case of the embodiment of FIG. 6, when a core layer signal and an enhanced layer signal are transferred both through transmit antenna 1 and through transmit antenna 2, but, contrary to the case of FIG. 2, the signals are crossed and transferred between the antennas, the first signaling information may be transferred as a value of ‘01’. Alternatively, when a core layer signal and an enhanced layer signal are combined with each other and a combined signal is transferred only to transmit antenna 1, as in the case of the embodiment of FIG. 1, the first signaling information may be transferred as a value of ‘10’. Alternatively, when a core layer signal and an enhanced layer signal are combined with each other and a combined signal is transferred only to transmit antenna 2 by means of cross-transfer between antennas, contrary to the embodiment of FIG. 1, the first signaling information may be transferred as a value of ‘11’.

In this case, all of the transmission structures illustrated in the embodiment of FIG. 12 may or may not be applied to a broadcasting system to which LDM technology and MIMO technology are combined. When two or more transmission structures are applied, the transmission structures based on a combination of technologies may be signaled using the value of one or more bits, and the signaling information may then be provided to the receiver.

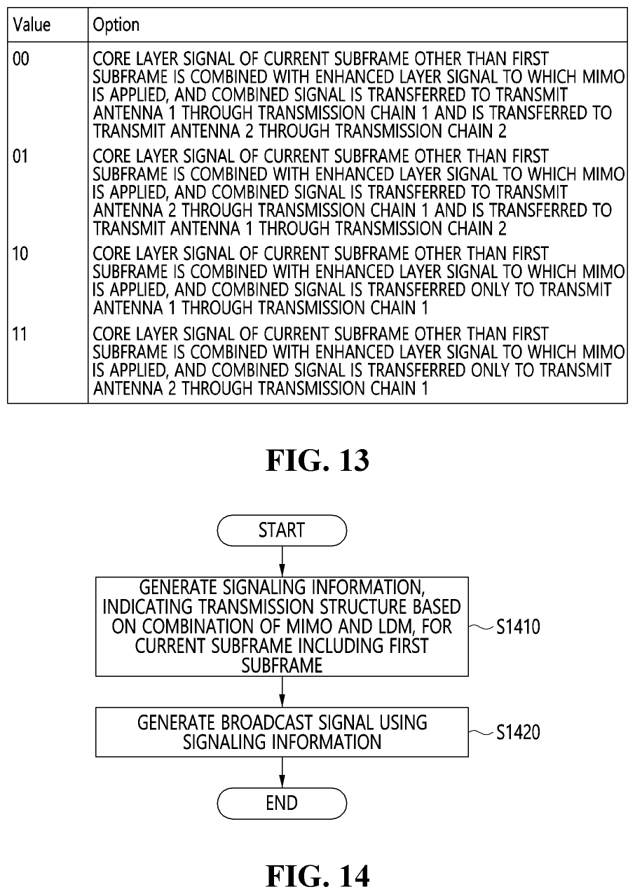

In another example, FIG. 13 defines L1D_lyrd_mimo_cl_pol, which is an example of second signaling information about a transmission structure indicating how MIMO technology and LDM technology are combined with the current subframe subsequent to the first subframe.

Referring to FIG. 13, for the current subframe subsequent to the first subframe, when a core layer signal and an enhanced layer signal are combined with each other and a combined signal is transferred both through transmit antenna 1 and through transmit antenna 2, as in the case of the embodiment of FIG. 2, the second signaling information may be transferred as a value of ‘00’. Alternatively, as in the case of the embodiment of FIG. 6, when a core layer signal and an enhanced layer signal are transferred both through transmit antenna 1 and through transmit antenna 2, but, contrary to the case of FIG. 2, the signals are crossed and transferred between the antennas, the second signaling information may be transferred as a value of ‘01’. Alternatively, when a core layer signal and an enhanced layer signal are combined with each other and a combined signal is transferred only to transmit antenna 1, as in the case of the embodiment of FIG. 1, the second signaling information may be transferred as a value of ‘10’ . Alternatively, when a core layer signal and an enhanced layer signal are combined with each other and a combined signal is transferred only to transmit antenna 2 by means of cross-transfer between antennas, contrary to the embodiment of FIG. 1, the second signaling information may be transferred as a value of ‘11’.

In this case, all of the transmission structures illustrated in the embodiment of FIG. 13 may or may not be applied to a broadcasting system to which LDM technology and MIMO technology are combined. When two or more transmission structures are applied, the transmission structures based on a combination of technologies may be signaled using the value of one or more bits, and the signaling information may then be provided to the receiver.

Here, in order for the existing receiver to normally receive the broadcast signal transferred to the core layer, L1-Signaling information identical to that of the existing receiver and configuration thereof need to be maintained.

Therefore, the present disclosure may add information, such as L1B_first_sub_lyrd_cl_pol and L1D_lyrd_mimo_cl_pol, to a position subsequent to the existing signaling information, thus transmitting/receiving broadcast signals by combining MIMO technology with LDM technology without influencing the existing receiver.

Table 1 and Table 2 show examples of signaling that is capable of providing a transmission structure based on a combination of MIMO technology and LDM technology without influencing signaling to be acquired by the existing receiver according to the present disclosure.

TABLE 1

| | No. of | |
|---|---|---|
| Syntax | Bits | Format |
| L1_Basic_signaling( ) { | | |
| L1B_version | 3 | uimsbf |
| L1b_mimo_scattered_pilot_encoding | 1 | uimsbf |
| L1B_lls_flag | 1 | uimsbf |
| L1B_time_info_flag | 2 | uimsbf |
| L1B_return_channel_flag | 1 | uimsbf |
| L1B_papr_reduction | 2 | uimsbf |
| L1B_frame_length_mode | 1 | uimsbf |
| if(L1B_frame_length_mode=0){ | | |
| L1B_frame_length | 10 | uimsbf |
| L1B_excess_samples_per_symbol | 13 | uimsbf |
| }else{ | | |
| L1B_time_offset | 16 | uimsbf |
| L1B_additional_sanples | 7 | uimsbf |
| } | | |
| L1B_num_subframes | 8 | uimsbf |
| L1B_preamble_num_symbols | 3 | uimsbf |
| L1B_preamble_reduced_carriers | 3 | uimsbf |
| L1B_L1_Detail_content_tag | 2 | uimsbf |
| L1B_L1_Detail_size_bytes | 1 | uimsbf |
| L1B_L1_Detail_fec_type | 3 | uimsbf |
| L1B_L1_Detail_additional_parity_mode | 2 | uimsbf |
| L1B_L1_Detail_total_cells | 19 | uimsbf |
| L1B_first_sub_mimo | 1 | uimsbf |
| L1B_first_sub_miso | 2 | uimsbf |
| L1B_first_sub_fft_size | 2 | uimsbf |
| L1B_first_sub_reduced_carriers | 3 | uimsbf |
| L1B_first_sub_guard_interval | 4 | uimsbf |
| L1B_first_sub_num_ofdm_symbols | 11 | uimsbf |
| L1B_first_sub_scattered_pilot_pattern | 5 | uimsbf |
| L1B_first_sub_scattered_pilot_boost | 3 | uimsbf |
| L1B_first_sub_sbs_first | 1 | uimsbf |
| L1B_first_sub_sbs_last | 1 | uimsbf |
| L1B_first_sub_lyrd_mimo_cl_pol | 2 | uimsbf |
| L1B_reserved | 46 | uimsbf |
| L1B_crc | 32 | uimsbf |
| } | | |

Table 1 shows an example of configuration of basic transmission information L1-Basic Signaling that includes L1B_lyrd_mimo_cl_pol signaling indicating the transmission structure information of the first subframe.

TABLE 2

| Syntax | No. of Bits | Format |
|---|---|---|
| L1_Detatil_signaling( ) { | | |
| L1D_version | 4 | uimsbf |
| L1D_num_rf | 3 | uimsbf |
| for(L1D_rf_id=1..L1D_num_rf){ | | |
| L1D_bonded_bsid | 16 | uimsbf |
| reserved | 3 | bslbf |
| } | | |
| if(L1B_time_info_flag !=00){ | | |
| L1D_time_sec | 32 | uimsbf |
| L1D_time_msec | 10 | uimsbf |
| if(L1B_time_info_flag !=01){ | | |
| L1D_time_usec | 10 | uimsbf |
| If(L1B_time_info_flag !=10){ | | |
| L1D_time_nsec | 10 | uimsbf |
| } | | |
| } | | |
| } | | |
| for(i=0..L1B_num_subframes){ | | |
| if(i>0){ | | |
| L1D_mimo | 1 | uimsbf |
| L1D_miso | 2 | uimsbf |
| L1D_fft_size | 2 | uimsbf |
| L1D_reduced_carriers | 3 | uimsbf |
| L1D_guard_interval | 4 | uimsbf |
| L1D_num_ofdm_symbols | 11 | uimsbf |
| L1D_scattered pilot_pattern | 5 | uimsbf |
| L1D_scattered_pilot_boost | 3 | uimsbf |
| L1D_sbs-first | 1 | uimsbf |
| L1D_sbs_last | 1 | uimsbf |
| } | | |
| if(L1B_num_subframes>0){ | | |
| L1D_subframe_multiplex | 1 | uimsbf |
| } | | |
| L1D_frequency_interleaver | 1 | uimsbf |
| if(((i>0)&&(L1B_first_sub_sbs_first\|\|L1B_first_sub_sbs_last))\|\| | | |
| ((i>0)&&(L1D_sbs_first\|\|L1D_sbs_last))){ | | |
| L1D_sbs_null_cells | 13 | uimsbf |
| } | | |
| L1D_num_plp | 6 | uimsbf |
| for(j=0..L1D_num_plp){ | | |
| L1D_plp_id | 6 | uimsbf |
| L1D_plp_lls_flag | 1 | uimsbf |
| L1D_plp_layer | 2 | uimsbf |
| L1D_plp_start | 24 | uimsbf |
| L1D_plp_size | 24 | uimsbf |
| L1D_plp_scrambler_type | 2 | uimsbf |
| L1D_plp_fec_type | 4 | uimsbf |
| if(L1D_plp_fec_typeϵ{0,1,2,3,4,5}){ | | |
| L1D_plp_mod | 4 | uimsbf |
| L1D_plp_cod | 4 | uimsbf |
| } | | |
| L1D_plp_TI_mode | 2 | uimsbf |
| if(L1D_plp_TI_mode=00){ | | |
| L1D_plp_fec_block_start | 15 | uimsbf |
| }else if(L1D_plp_TI_mode=01){ | | |
| L1D_plp_CTI_fec_block_start | 22 | uimsbf |
| } | | |
| if(L1D_num_rf>0){ | | |
| L1D_plp_num_channel_bonded | 3 | uimsbf |
| If(L1D_plp_num_channel_bonded>0){ | | uimsbf |
| L1D_plp_channel_bonding_format | 2 | uimsbf |
| for(k=0..L1D_plp_num_channel_bonded){ | | |
| L1D_plp_bonded_rf_id | 3 | uimsbf |
| } | | |
| } | | |
| } | | |
| if(i=0&&L1B_first_sub_mimo=1)\|\|(i>0&&L1D_mimo=1){ | | |
| L1D_plp_mimo_strean_combining | 1 | uimsbf |
| L1D_plp_mimo_IQ_interleaving | 1 | uimsbf |
| L1D_plp_mimo_PH | 1 | uimsbf |
| } | | |
| if(L1D_plp_layer=0){ | | |
| L1D_plp_type | 1 | uimsbf |
| if(L1D_plp_type=1){ | | |
| L1D_plp_num_subslices | 14 | uimsbf |
| L1D_plp_subslice_interval | 24 | uimsbf |
| } | | |
| if(((L1D_plp_TI_mode+01\|\| | | uimsbf |
| (L1D_plp_TI_mode=10))&&(L1D_plp_mod=0000)){ | | |
| L1D_plp_TI_extended_interleaving | 1 | uimsbf |
| } | | |
| if(L1D_plp_TI_mode=01){ | | |
| L1D_plp_CTI_depth | 3 | uimsbf |
| L1D_plp_CTI_start_row | 11 | uimsbf |
| }else if(L1D_plp_TI_mode=10){ | | |
| L1D_plp_HTI_inter_subframe | 1 | uimsbf |
| L1D_plp_HTI_num_ti_blocks | 4 | uimsbf |
| L1D_plp_HTI_num_fec_clocks_max | 12 | uimsbf |
| if(L1D_plp_HTI_inter_subframe=0){ | | |
| L1D_plp_HTI_num_fec_blocks | 12 | uimsbf |
| }else{ | | |
| for(k=0..L1D_plp_HTI_num_ti_blocks){ | | |
| L1D_plp_HTI_num_fec_block | 12 | uimsbf |
| } | | |
| } | | |
| L1D_plp_HTI_cell_interleaver | 1 | uimsbf |
| } | | |
| }else{ | | |
| L1D_plp_ldm_injection_level | 5 | uimsbf |
| } | | |
| } | | |
| } | | |
| L1D_bsid | 16 | uimsbf |
| for(i=0..L1B_num_subframes){ | | |
| if(I>0){ | | |
| L1D_lyrd_mimo_cl_pol | 2 | uimsbf |
| } | | |
| } | | |
| L1D_reserved | as needed | |
| L1D_crc | 32 | |
| } | | |

Table 2 shows an example of configuration of detailed transmission information L1-Detail Signaling that includes L1D_lyrd_mimo_cl_pol signaling indicating the transmission structure information of a subframe subsequent to the first subframe.

Here, each of the first signaling information and the second signaling information may further indicate that a combination of MIMO technology and LDM technology is not applied.

For example, information, indicating that a combination of MIMO technology and LDM technology is not applied, and a bit indicating the information may be additionally assigned to the embodiments of FIGS. 12 and 13, and thus whether MIMO technology and LDM technology are combined may also be signaled through the first signaling information and the second signaling information. Here, although, in FIGS. 12 and 13, pieces of information respectively corresponding to {00, 01, 10, 11} are signaled based on 2 bits, information to be additionally signaled may be included by extending bits corresponding to the value to 3 bits or 4 bits.

Further, the broadcast signal transmission method according to the embodiment of the present disclosure generates a broadcast signal using the first signaling information and the second signaling information at step S1030.

Here, a first receiver that supports only LDM technology may receive a combined signal, and may demodulate only a core layer signal from the combined signal and process an enhanced layer signal as a noise signal.

For example, the existing receiver illustrated in FIG. 3 may interpret the basic transmission information L1-Basic Signaling by reading the information up to an interpretable range ‘L1B_first_sub_sbs_last’ in Table 1, may be operated in conformity with the interpreted information, and may process the remaining information including ‘L1B_first_sub_lyrd_mimo_cl_pol’ as ‘L1B_reserved’. Furthermore, the existing receiver may interpret the detailed transmission information L1 -Detail Signaling by reading the information up to an interpretable range ‘L1D_plp_ldm_injection_level’ or ‘L1D_bsid’ in Table 2, may regard the remaining information as ‘L1D_reserved’ and may then be operated in conformity with the interpreted information.

Therefore, the existing receiver according to the embodiment of FIG. 3 may recognize that MIMO technology is not applied to the received terrestrial broadcast signal, but LDM technology is applied thereto, and may demodulate only a core layer signal and recognize an enhanced layer signal as noise that cannot be demodulated.

In this case, a second receiver that supports both LDM technology and MIMO technology may receive a combined signal, and may individually demodulate a core layer signal and an enhanced layer signal from the combined signal.

In this case, the second receiver may acquire information about the transmission structure of the first subframe of the current broadcast signal frame through the first signaling information, and may acquire information about the transmission structure of the current subframe subsequent to the first subframe of the current broadcast signal frame through the second signaling information.

For example, the receiver illustrated in FIGS. 4 and 9 may acquire information about the transmission structure of the first subframe of the current broadcast signal frame based on a combination of MIMO technology and LDM technology through signaling of the basic transmission information ‘L1B_first_sub_lyrd_mimo_cl_pol’ of the basic transmission information L1-Basic Signaling indicated in Table 1. Furthermore, when there are multiple subframes, information about the transmission structures of subframes following the first subframe of the current broadcast signal frame based on a combination of MIMO technology and LDM technology may be acquired through signaling of ‘L1D_lyrd_mimo_cl_pol’ of the detailed transmission information L1-Detail Signaling indicated in Table 2.

By means of the broadcast signal transmission method, the performance of a broadcasting system to which MIMO technology and LDM technology are applied may be improved.

Furthermore, the present disclosure may provide a broadcasting service to which a combination of MIMO technology and LDM technology is applied while maintaining compatibility with an existing receiver.

Furthermore, the present disclosure may efficiently provide a broadcasting system by managing a transmit antenna depending on the purpose of service, and may improve reception performance by controlling a receiving antenna and an operation when signaling information indicating a signal transmission structure based on a combination of MIMO technology and LDM technology is transferred.

Furthermore, the present disclosure may allow an existing terminal to which a combination of MIMO technology and LDM technology is not applied to receive a terrestrial broadcast signal including a core layer signal and to acquire transmission information in the same manner as an existing scheme.

FIG. 14 is an operation flowchart illustrating a broadcast signal transmission method according to another embodiment of the present disclosure.

Referring to FIG. 14, the broadcast signal transmission method according to the other embodiment of the present disclosure generates signaling information, indicating a transmission structure based on a combination of Multiple-Input Multiple-Output (MIMO technology and Layered Division Multiplexing (LDM) technology, for a current subframe including a first subframe of a current broadcast signal frame at step S1410.

Here, the signaling information may be included in detailed transmission information L1-DETAIL SIGNAL in the preamble of a broadcast signal.

Here, because the combination of MIMO technology and LDM technology may be applied to each subframe, signaling information may be configured on a subframe basis.

Here, the signaling information may indicate a transmission chain through which a combined signal of a core layer signal and an enhanced layer signal passes, and a transmit antenna to which the combined signal is transferred.

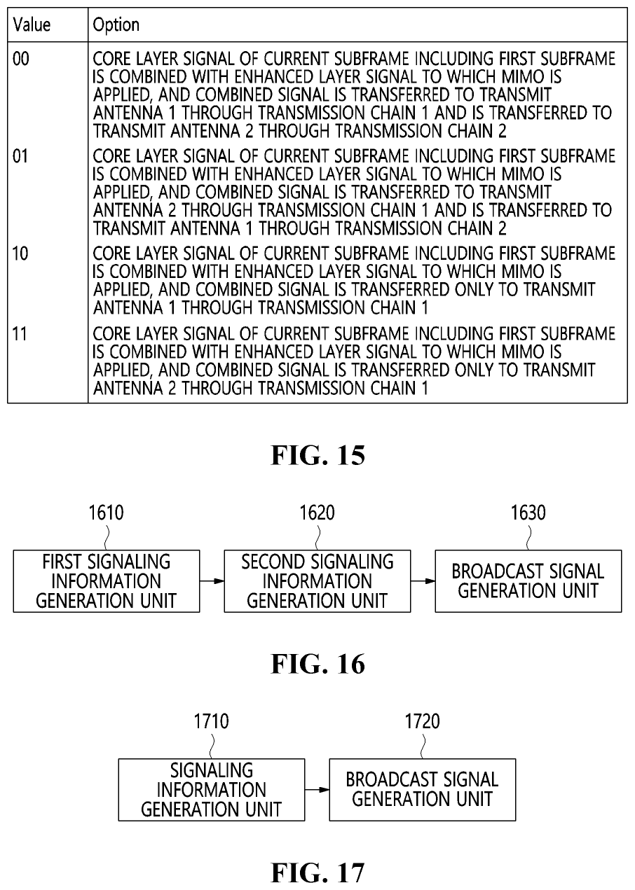

In an example, FIG. 15 defines L1D_lyrd_mimo_cl_pol, which is an example of the signaling information about a transmission structure indicating how MIMO technology and LDM technology are combined with the current subframe including the first subframe of the current broadcast signal frame.

Referring to FIG. 15, for the current subframe including the first subframe, when a core layer signal and an enhanced layer signal are combined with each other and a combined signal is transferred both through transmit antenna 1 and through transmit antenna 2, as in the case of the embodiment of FIG. 2, the signaling information may be transferred as a value of ‘00’. Alternatively, as in the case of the embodiment of FIG. 6 when a core layer signal and an enhanced layer signal are transferred both through transmit antenna 1 and transmit antenna 2, but, contrary to the case of FIG. 2, the signals are crossed and transferred between the antennas, the signaling information may be transferred as a value of ‘01’. Alternatively, when a core layer signal and an enhanced layer signal are combined with each other and a combined signal is transferred only through transmit antenna 1, as in the case of the embodiment of FIG. 1, the signaling information may be transferred as a value of ‘10’. Alternatively, when a core layer signal and an enhanced layer signal are combined with each other and a combined signal is transferred only through transmit antenna 2 by means of cross-transfer between antennas, contrary to the embodiment of FIG. 1, the signaling information may be transferred as a value of ‘11’.

In this case, all of the transmission structures illustrated in the embodiment of FIG. 15 may or may not be applied to a broadcasting system to which LDM technology and MIMO technology are combined. When two or more transmission structures are applied, the transmission structures based on a combination of technologies may be signaled using the value of one or more bits, and the signaling information may then be provided to the receiver.

Further, in FIG. 15, L1-Basic Signaling is identical to that in current terrestrial broadcast transmission, and thus there is an advantage in that a change in the configuration of signaling information may be slightly reduced from the standpoint of the existing receiver.

Table 3 shows an example of signaling capable of providing the transmission structure of FIG. 15.

TABLE 3

| Syntax | No. of Bits | Format |
|---|---|---|
| L1_Detatil_signaling( ) { | | |
| L1D_version | 4 | uimsbf |
| L1D_num_rf | 3 | uimsbf |
| for(L1D_rf_id=1..L1D_num_rf){ | | |
| L1D_bonded_bsid | 16 | uimsbf |
| reserved | 3 | bslbf |
| } | | |
| if(L1B_time_info_flag !=00){ | | |
| L1D_time _sec | 32 | uimsbf |
| L1D_time_msec | 10 | uimsbf |
| if(L1B_time_info_flag !=01){ | | |
| L1D_time_usec | 10 | uimsbf |
| If(L1B_time_info_flag !=10){ | | |
| L1D_time_nsec | 10 | uimsbf |
| } | | |
| } | | |
| } | | |
| for(i=0..L1B_num_subframes){ | | |
| if(i>0){ | | |
| L1D_mimo | 1 | uimsbf |
| L1D_miso | 2 | uimsbf |
| L1D_fft_size | 2 | uimsbf |
| L1D_reduced_carriers | 3 | uimsbf |
| L1D_guard_interval | 4 | uimsbf |
| L1D_num_ofdm_symbols | 11 | uimsbf |
| L1D_scattered_pilot_pattern | 5 | uimsbf |
| L1D_scattered_pilot_boost | 3 | uimsbf |
| L1D_sbs_first | 1 | uimsbf |
| L1D_sbs_last | 1 | uimsbf |
| } | | |
| if(L1B_num_subframes>0){ | | |
| L1D_subframe_multiplex | 1 | uimsbf |
| } | | |
| L1D_frequency_interleaver | 1 | uimsbf |
| if(((i=0)&&(L1B_first_sub_sbs_first\|L1B_first_sub_sbs_last))\|\| | | |
| ((i>0)&&(L1D_sbs_first\|\|L1D_sbs_last))){ | | |
| L1D_sbs_null_cells | 13 | uimsbf |
| } | | |
| L1D_num_plp | 6 | uimsbf |
| for(j=0..L1D_num_plp){ | | |
| L1D_plp_id | 6 | uimsbf |
| L1D_plp_lls_flag | 1 | uimsbf |
| L1D_plp_layer | 2 | uimsbf |
| L1D_plp_start | 24 | uimsbf |
| L1D_plp_size | 24 | uimsbf |
| L1D_plp_scrambler_type | 2 | uimsbf |
| L1D_plp_fec_type | 4 | uimsbf |
| if(L1D_plp_fec_type={0,1,2,3,4,5}){ | | |
| L1D_plp_mod | 4 | uimsbf |
| L1D_plp_cod | 4 | uimsbf |
| } | | |
| L1D_plp_TI_mode | 2 | uimsbf |
| if(L1D_plp_TI_mode=00){ | | |
| L1D_plp_fec_block_start | 15 | uimsbf |
| }else if(L1D_plp_TI_mode=01){ | | |
| L1D_plp_CTI_fec_block_start | 22 | uimsbf |
| } | | |
| if(L1D_num_rf>0){ | | |
| L1D_plp_num_channel_bonded | 3 | uimsbf |
| If(L1D_plp_num_channel_bonded>0){ | | |
| L1D_plp_channel_bonding_format | 2 | uimsbf |
| for(k=0..L1D_plp_num_channel_bonded){ | | |
| L1D_plp_bonded_rf_id | 3 | uimsbf |
| } | | |
| } | | |
| } | | |
| if(i=0&&L1B_first_sub_mimo=1)\|\|(i>0&&L1D_mimo=1){ | | |
| L1D_plp_mimo_stream_combining | 1 | uimsbf |
| L1D_plp_mimo_IQ_interleaving | 1 | uimsbf |
| L1D_plp_mimo_PH | 1 | uimsbf |
| } | | |
| if(L1D_plp_layer=0){ | | |
| L1D_plp_type | 1 | uimsbf |
| if(L1D_plp_type=1){ | | |
| L1D_plp_num_subslices | 14 | uimsbf |
| L1D_plp_subslice_interval | 24 | uimsbf |
| } | | |
| if(((L1D_plp_TI_mode+01\|\| | | |
| (L1D_plp_TI_mode=10))&&(L1D_plp_mod=0000)){ | | |
| L1D_plp_TI_extended_interleaving | 1 | uimsbf |
| } | | |
| if(L1D_plp_TI_mode=01){ | | |
| L1D_plp_CTI_depth | 3 | uimsbf |
| L1D_plp_CTI_start_row | 11 | uimsbf |
| }else if(L1D_plp_TI_mode=10){ | | |
| L1D_plp_HTI_inter_subframe | 1 | uimsbf |
| L1D_plp_HTI_num_ti_blocks | 4 | uimsbf |
| L1D_plp_HTI_num_fec_clocks_max | 12 | uimsbf |
| if(L1D_plp_HTI_inter_subframe=0){ | | |
| L1D_plp_HTI_num_fec_blocks | 12 | uimsbf |
| }else{ | | |
| for(k=0..L1D_plp_HTI_num_ti_blocks){ | | |
| L1D_plp_HTI_num_fec_block12 | | uimsbf |
| } | | |
| } | | |
| L1D_plp_HTI_cell_interleaver | 1 | uimsbf |
| } | | |
| }elese{ | | |
| L1D_plp_ldm_injection_level | 5 | uimsbf |
| } | | |
| } | | |
| } | | |
| L1D_bsid | 16 | uimsbf |
| for(i=0..L1B_num_subframes){ | | |
| L1D_lyrd_mimo_cl_pol | 2 | uimsbf |
| } | | |
| L1D_reserved | as needed | |
| L1D_crc | 32 | |
| } | | |

Here, the signaling information may further indicate that a combination of MIMO technology and LDM technology is not applied.

For example, information indicating that a combination of MIMO technology and LDM technology is not applied and a bit indicating the information may be additionally assigned to the embodiment of FIG. 15, and thus whether MIMO technology and LDM technology are combined may be signaled through the signaling information. Here, although, in FIG. 15, pieces of information respectively corresponding to {00, 01, 10, 11} are signaled based on 2 bits, information to be additionally signaled may be included by extending bits corresponding to the value to 3 bits or 4 bits.

Furthermore, the signal transmission method according to the embodiment of the present disclosure generates a broadcast signal using the signaling information at step S1420.

Here, a first receiver that supports only LDM technology may receive a combined signal, and may demodulate only a core layer signal from the combined signal and process an enhanced layer signal as a noise signal.

In this case, a second receiver that supports both LDM technology and MIMO technology may receive a combined signal, and may individually demodulate a core layer signal and an enhanced layer signal from the combined signal.

In this case, the second receiver may acquire information about a transmission structure indicating how MIMO technology and LDM technology are combined with the current subframe including the first subframe, through the signaling information.

By means of the broadcast signal transmission method, the performance of a broadcasting system to which MIMO technology and LDM technology are applied may be improved.

Furthermore, the present disclosure may provide a broadcasting service to which a combination of MIMO technology and LDM technology is applied while maintaining compatibility with an existing receiver.

Furthermore, the present disclosure may efficiently provide a broadcasting system by managing a transmit antenna depending on the purpose of service, and may improve reception performance by controlling a receiving antenna and an operation when signaling information indicating a signal transmission structure based on a combination of MIMO technology and LDM technology is transferred.

Furthermore, the present disclosure may allow an existing terminal to which a combination of MIMO technology and LDM technology is not applied to receive a terrestrial broadcast signal including a core layer signal and to acquire transmission information in the same manner as an existing scheme.

FIG. 16 is a block diagram illustrating a broadcast signal transmission apparatus according to an embodiment of the present disclosure.

Referring to FIG. 16, the broadcast signal transmission apparatus according to the embodiment of the present disclosure includes a first signaling information generation unit 1610, a second signaling information generation unit 1620, and a broadcast signal generation unit 1630.

The first signaling information generation unit 1610 generates first signaling information, indicating a transmission structure based on a combination of MIMO technology and LDM technology, for a first subframe of a current broadcast signal frame.

The second signaling information generation unit 1620 generates second signaling information, indicating a transmission structure based on a combination of MIMO technology and LDM technology, for a current subframe subsequent to the first subframe.

Here, the first signaling information may be included in basic transmission information L1-BASIC SIGNAL of the preamble of a broadcast signal, and the second signaling information may be included in detailed transmission information L1-DETAIL SIGNAL of the preamble of the broadcast signal.

Here, because the combination of MIMO technology and LDM technology may be applied to each subframe, signaling information may be configured on a subframe basis.

Here, each of the first signaling information and the second signaling information may indicate a transmission chain through which a combined signal of a core layer signal and an enhanced layer signal passes, and a transmit antenna to which the combined signal is transferred.

Here, the first signaling information and the second signaling information may further indicate that a combination of MIMO technology and LDM technology is not applied.

The broadcast signal generation unit 1630 generates a broadcast signal using the first signaling information and the second signaling information.

Here, a first receiver that supports only LDM technology may receive a combined signal, and may demodulate only a core layer signal from the combined signal and process an enhanced layer signal as a noise signal.

In this case, a second receiver that supports both LDM technology and MIMO technology may receive a combined signal, and may individually demodulate a core layer signal and an enhanced layer signal from the combined signal.

In this case, the second receiver may acquire information about the transmission structure of the first subframe of the current broadcast signal frame through the first signaling information, and may acquire information about the transmission structure of the current subframe subsequent to the first subframe of the current broadcast signal frame through the second signaling information.

By utilizing the broadcast signal transmission apparatus, the performance of a broadcasting system to which MIMO technology and LDM technology are applied may be improved.

Furthermore, the present disclosure may provide a broadcasting service to which a combination of MIMO technology and LDM technology is applied while maintaining compatibility with an existing receiver.

Furthermore, the present disclosure may efficiently provide a broadcasting system by managing a transmit antenna depending on the purpose of service, and may improve reception performance by controlling a receiving antenna and an operation when signaling information indicating a signal transmission structure based on a combination of MIMO technology and LDM technology is transferred.

Furthermore, the present disclosure may allow an existing terminal to which a combination of MIMO technology and LDM technology is not applied to receive a terrestrial broadcast signal including a core layer signal and to acquire transmission information in the same manner as an existing scheme.

FIG. 17 is a block diagram illustrating a broadcast signal transmission apparatus according to another embodiment of the present disclosure.

Referring to FIG. 17, the broadcast signal transmission apparatus according to the other embodiment of the present disclosure includes a signaling information generation unit 1710 and a broadcast signal generation unit 1720.

The signaling information generation unit 1710 generates signaling information, indicating a transmission structure based on a combination of MIMO technology and LDM technology, for a current subframe including a first subframe of a current broadcast signal frame.

Here, the signaling information may be included in detailed transmission information L1-DETAIL SIGNAL in the preamble of a broadcast signal.

Here, because the combination of MIMO technology and LDM technology may be applied to each subframe, signaling information may be configured on a subframe basis.

Here, the signaling information may indicate a transmission chain through which a combined signal of a core layer signal and an enhanced layer signal passes, and a transmit antenna to which the combined signal is transferred.

The broadcast signal generation unit 1720 generates a broadcast signal using the signaling information.

Here, a first receiver that supports only LDM technology may receive a combined signal, and may demodulate only a core layer signal from the combined signal and process an enhanced layer signal as a noise signal.

In this case, a second receiver that supports both LDM technology and MIMO technology may receive a combined signal, and may individually demodulate a core layer signal and an enhanced layer signal from the combined signal.

In this case, the second receiver may acquire information about a transmission structure related to a combination of MIMO technology and LDM technology with the current subframe including the first subframe, through the signaling information.

By utilizing the broadcast signal transmission apparatus, the performance of a broadcasting system to which MIMO technology and LDM technology are applied may be improved.

Further, the present disclosure may provide a broadcasting service to which a combination of MIMO technology and LDM technology is applied while maintaining compatibility with an existing receiver.

Furthermore, the present disclosure may efficiently provide a broadcasting system by managing a transmit antenna depending on the purpose of service, and may improve reception performance by controlling a receiving antenna and an operation when signaling information indicating a signal transmission structure based on a combination of MIMO technology and LDM technology is transferred.

Furthermore, the present disclosure may allow an existing terminal to which a combination of MIMO technology and LDM technology is not applied to receive a terrestrial broadcast signal including a core layer signal and to acquire transmission information in the same manner as an existing scheme.

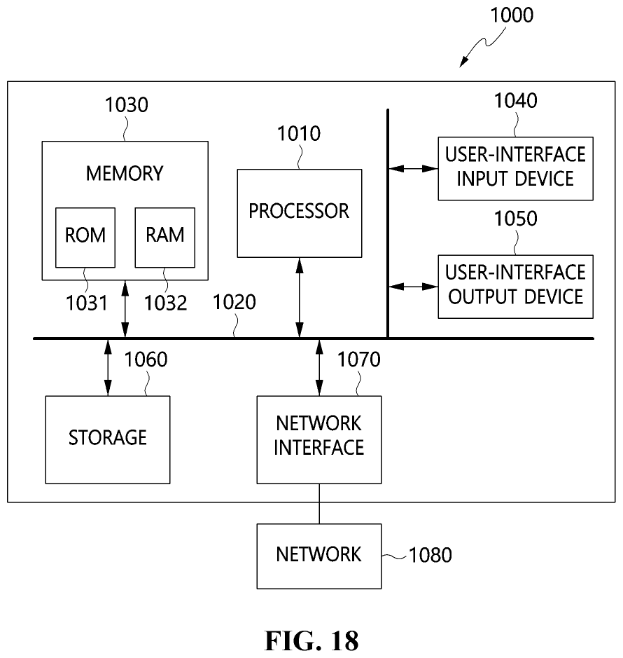

FIG. 18 is a diagram illustrating a computer system according to an embodiment of the present disclosure.

Referring to FIG. 18, the embodiment of the present disclosure may be implemented in a computer system such as a computer-readable storage medium. As illustrated in FIG. 18, a computer system 1800 may include one or more processors 1810, memory 1830, a user interface input device 1840, a user interface output device 1850, and storage 1860, which communicate with each other through a bus 1820. The computer system 1800 may further include a network interface 1870 connected to a network 1880. Each processor 1810 may be a Central Processing Unit (CPU) or a semiconductor device for executing processing instructions stored in the memory 1830 or the storage 1860. Each of the memory 1830 and the storage 1860 may be any of various types of volatile or nonvolatile storage media. For example, the memory 1830 may include Read-Only Memory (ROM) 1831 or Random Access Memory (RAM) 1832.

Here, the configuration illustrated in each of FIGS. 16 and 17 may correspond to or be included in the processor 1810 of FIG. 18.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

According to the present disclosure, the performance of a broadcasting system to which Multiple-Input Multiple-Output (MIMO) technology and Layered Division Multiplexing (LDM) technology are applied may be improved.

Further, the present disclosure may provide a broadcasting service to which a combination of MIMO technology and LDM technology is applied while maintaining compatibility with an existing receiver.

Furthermore, the present disclosure may efficiently provide a broadcasting system by managing a transmit antenna depending on the purpose of service, and may improve reception performance by controlling a receiving antenna and an operation when signaling information indicating a signal transmission structure based on a combination of MIMO technology and LDM technology is transferred.

Furthermore, the present disclosure may allow an existing terminal to which a combination of MIMO technology and LDM technology is not applied to receive a terrestrial broadcast signal including a core layer signal and to acquire transmission information in the same manner as an existing scheme.

As described above, in the broadcast signal transmission method for signaling a transmission structure based on a combination of LDM technology and MIMO technology and the apparatus using the same according to the present disclosure, the configurations and schemes in the above-described embodiments are not limitedly applied, and some or all of the above embodiments can be selectively combined and configured so that various modifications are possible.

What is claimed is:

1. A broadcast signal transmission method, comprising:
generating first signaling information, indicating a transmission structure based on a combination of Multiple-Input Multiple-Output (MIMO) technology and Layered Division Multiplexing (LDM) technology, for a first subframe of a current broadcast signal frame;
generating second signaling information, indicating a transmission structure based on a combination of the MIMO technology and the LDM technology, for a current subframe subsequent to the first subframe; and
generating a broadcast signal using the first signaling information and the second signaling information.

2. The broadcast signal transmission method of claim 1, wherein:
the first signaling information is included in basic transmission information (L1-BASIC SIGNAL) of a preamble of the broadcast signal, and the second signaling information is included in detailed transmission information (L1-DETAIL SIGNAL) of the preamble of the broadcast signal.

3. The broadcast signal transmission method of claim 2, wherein each of the first signaling information and the second signaling information indicates a transmission chain through which a combined signal of a core layer signal and an enhanced layer signal passes, and a transmit antenna to which the combined signal is transferred.

4. The broadcast signal transmission method of claim 3, wherein each of the first signaling information and the second signaling information further indicates that a combination of the MIMO technology and the LDM technology is not applied.

5. The broadcast signal transmission method of claim 3, wherein a first receiver that supports only the LDM technology receives the combined signal, demodulates only the core layer signal from the combined signal, and processes the enhanced layer signal as a noise signal.

6. The broadcast signal transmission method of claim 5, wherein a second receiver that supports both the LDM technology and the MIMO technology receives the combined signal, and individually demodulates the core layer signal and the enhanced layer signal from the combined signal.

7. The broadcast signal transmission method of claim 6, wherein the second receiver acquires information about the transmission structure of the first subframe of the current broadcast signal frame through the first signaling information, and acquires information about the transmission structure of the current subframe subsequent to the first subframe of the current broadcast signal frame through the second signaling information.

8. A broadcast signal transmission method, comprising:
generating signaling information, indicating a transmission structure based on a combination of Multiple-Input Multiple-Output (MIMO) technology and Layered Division Multiplexing (LDM) technology, for a current subframe including a first subframe of a current broadcast signal frame; and
generating a broadcast signal using the signaling information.

9. A broadcast signal transmission apparatus, comprising:
a first signaling information generation unit for generating first signaling information, indicating a transmission structure based on a combination of Multiple-Input Multiple-Output (MIMO) technology and Layered Division Multiplexing (LDM) technology, for a first subframe of a current broadcast signal frame;
a second signaling information generation unit for generating second signaling information, indicating a transmission structure based on a combination of the MIMO technology and the LDM technology, for a current subframe subsequent to the first subframe; and
a broadcast signal generation unit for generating a broadcast signal using the first signaling information and the second signaling information.

10. The broadcast signal transmission apparatus of claim 9, wherein:
the first signaling information is included in basic transmission information (L1-BASIC SIGNAL) of a preamble of the broadcast signal, and
the second signaling information is included in detailed transmission information (L1-DETAIL SIGNAL) of the preamble of the broadcast signal.

11. The broadcast signal transmission apparatus of claim 10, wherein each of the first signaling information and the second signaling information indicates a transmission chain through which a combined signal of a core layer signal and an enhanced layer signal passes, and a transmit antenna to which the combined signal is transferred.

12. The broadcast signal transmission apparatus of claim 11, wherein each of the first signaling information and the second signaling information further indicates that a combination of the MIMO technology and the LDM technology is not applied.

13. The broadcast signal transmission apparatus of claim 11, wherein a first receiver that supports only the LDM technology receives the combined signal, demodulates only the core layer signal from the combined signal, and processes the enhanced layer signal as a noise signal.

14. The broadcast signal transmission apparatus of claim 13, wherein a second receiver that supports both the LDM technology and the MIMO technology receives the combined signal, and individually demodulates the core layer signal and the enhanced layer signal from the combined signal.

15. The broadcast signal transmission apparatus of claim 14, wherein the second receiver acquires information about the transmission structure of the first subframe of the current broadcast signal frame through the first signaling information, and acquires information about the transmission structure of the current subframe subsequent to the first subframe of the current broadcast signal frame through the second signaling information.
